(19) United States
(12) Patent Application Publication
(10) Pub. No.: US 2014/0161551 A1
(43) Pub. Date: Jun. 12, 2014

(54) Rotary Tool, In Particular Reaming Tool and Adjustment Element For a Rotary Tool

(71) Applicant: Kennametal Inc., Latrobe, PA (US)

(72) Inventors: Robert Meyer, Allersberg (DE); Michael Schuffenhauer, Furth (DE); Armin Josef Zimmermann, Oberviechtach (DE); Bettina Wagner, Wernberg-Koblitz (DE)

(21) Appl. No.: 14/098,875

(22) Filed: Dec. 6, 2013

(30) Foreign Application Priority Data
Dec. 7, 2012 (DE) 102012222574.9

(51) Int. Cl. B23D 77/10

(52) U.S. Cl. CPC B23D 77/10
USPC 408/153

(57) ABSTRACT

In order to ensure highly precise setting, in particular readjustment of the radial position of the blade in the case of a rotary tool, in particular a reamer, an adjustment element, in particular in the form of an adjustment screw, having a cone formed by the screw head is inserted into an end-side receptacle in a cutting section, said cone being provided with a friction-reducing coating.

### BACKGROUND OF THE INVENTION

The invention relates to a rotary tool, in particular a reaming tool, having the features in the preamble of claim 1, and to an adjustment element for a rotary tool of this kind.

DE 10 2007 028 167 A1 and DE 1 962 181 each disclose a reamer as a rotary tool. In the case of such reaming tools, high precision in the setting of the exact radial blade position is required, since these reamers are used for the precision machining for example of drill holes. In order to readjust the radial blade position in the event of wear, the known reamers have a receptacle on the end side in the tool head, an adjustment element being inserted into said receptacle. Adjustment takes place by means of a conical element which is displaced in the axial direction and as a result radially widens the complementary conical receptacle. To this end, a conical sleeve, through which a screw passes in the longitudinal direction, is provided in DE 10 2007 028 167. When the screw is adjusted, the sleeve is moved smoothly in the longitudinal direction.

In DE 1 962 181, the entire reamer is assembled from a multiplicity of individual parts. In order to radially set the blades, use is made of a screw having a conical screw head. The two known variant embodiments are only suitable to a limited extent for use at small diameters of, for example, up to a maximum of 14 mm, since, at these small diameters, the multipart structure is generally no longer possible for reasons of mechanical stability.

At such small diameters, there is also the problem that radial precision setting is not possible or only possible to a limited extent in the context of the required tolerances.

### SUMMARY OF THE INVENTION

Proceeding herefrom, the invention is based on the object of specifying a rotary tool, in particular a reamer, in which highly precise radial precision adjustment is possible even at relatively small diameters.

The object is achieved according to the invention by a rotary tool, in particular a reaming tool such as a reamer, having the features of claim 1. The rotary tool comprises a cutting section or tool head extending along a center longitudinal axis, said cutting section or tool head having at least one blade on its circumference, wherein, in order to set the radial position of the at least one blade, an adjustment element having a cone is inserted into an end-side receptacle in the tool head, said adjustment element being displaceable in the axial direction in order to radially widen the cutting section. In order to allow highly precise adjustment, the cone and/or the receptacle are provided with a friction-reducing coating. A friction-reducing coating is understood here to mean that a coating is applied such that the coefficient of friction is reduced compared with the basic material of the adjustment element or of the receptacle

This configuration is based on the consideration that, in the case of the adjustment movement, on account of the increased static friction at the start of the adjustment movement compared with the subsequent sliding friction, a higher torque for the adjustment movement is generally required at the start, and this results in jerking movements and ultimately in tolerance deviations. In the case of conventional rotary tools, this would result, in particular at small diameters, in tolerance deviations which go beyond the permissible tolerance. The tolerance precision of the radial widening (diameter) is in this case expediently +−1 μm. As a result of the friction-reducing coating, this jerking movement is avoided, or at least considerably reduced, and so a highly precise precision adjustment capability within narrow tolerance limits of +−1 μm can be achieved.

Expediently, during the adjustment movement, the cone rotates with respect to the receptacle about the center longitudinal axis. In particular, the cone is formed in this case by the screw head of a screw forming the adjustment element. As a result, effective precision adjustment is possible by way of a simple one-piece adjustment element, specifically the screw. A multipart structure is not required. The adjustment movement is transmitted directly from the adjustment element to the receptacle. Complicated, multipart decoupling between the adjustment screw and the cone, which would require too large an installation space, is not required.

For the purposes of a configuration which is as compact as possible, the tool is formed overall in the manner of a monobloc tool, which thus has a one-piece, unitary main tool body having a shank section and a cutting section. Only the adjustment element, formed in particular as a screw, is formed as an additional element. The blades are formed, as usual, as separate cutting elements from a specific material which is harder than the material of the carrier. The blades are in this case optionally soldered-in blades or interchangeably secured cutting bodies.

In an expedient development, in addition to the cone of the screw head, preferably also the screw thread, which is formed in particular as a fine thread, is provided with a friction-reducing coating.

A DLC (diamond-like carbon) coating is expediently used as the coating. Such a coating is applied preferably as a fine or thin coating having a layer thickness for example in the range of 2 to 4 μm. The application process used is usually a CVD (chemical vapor deposition) process or a PVD (physical vapor deposition) process.

On account of its compactness, which is achieved in particular on account of the use of a monobloc carrier and the use of the screw as a one-part adjustment element, a rotary tool of this type is suitable for small diameters. The nominal diameter is in this case preferably at a maximum of 14 mm and typically in a range from 6 to 14 mm.

In an expedient development, the adjustment element has a stop surface which is formed in particular by the underside of the conical screw head. The stop surface is assigned a corresponding counter-stop surface on the receptacle. These two stop surfaces are in this case arranged, taking into account the conicity of the receptacle and that of the screw head, in such a way that the adjustment movability in the axial direction is limited such that a radial expansion limit of the receptacle is not exceeded. This thus ensures that the radial widening is always within the elastic expansion limit of the receptacle and the receptacle is not excessively expanded.

The expansion limit selected is in this case expediently three times the degree of tolerance IT6 according to the Standard EN ISO 286-1. Accordingly, depending on the nominal diameter of the tool, the expansion limit is in the range of about 25 to 35 μm. According to IT6, the tolerance is 8 μm for nominal diameters up to 6 mm, 9 μm for nominal diameters up to 10 mm and 11 μm for nominal diameters up to 18 mm.

The adjustment element usually serves exclusively for precision readjustment, for example in the case of wear of the reaming blades arranged on the circumference. Therefore, there is usually only one possible adjustment direction, specifically in the direction of radial widening. If the screw is overtightened and there is excessive radial widening, there is often the problem in conventional adjustment mechanisms that it is not possible to return to a narrower radius or at least this is not possible with the required precision. However, in the case of the adjustment screw described here, this is in principle possible. In order, in the case of overtightening, to also readily allow a slight correction with great precision, the cone, that is to say the screw head, has a circumferential outer bevel in the region of the largest diameter. By way of this bevel, wedging of the screw head during turning back, which would in turn result in jerking or a briefly increased torque, is avoided. Such wedging could in turn result in abrupt position changes, so that the desired high precision of the precision adjustment of the radial position would not be reliably ensured.

According to a preferred development, on its opposite end sides, the adjustment element has in each case guide receptacles having a centering bevel. Expediently, the shank-side guide receptacle is part of a central coolant duct passing at least partially through the adjustment means.

These guide receptacles are of particular significance for production with the required high roundness precision. The guide receptacles are arranged coaxially with the center longitudinal axis and serve for the exactly concentric clamping in of the adjustment element in a machine tool, with the aid of which the desired conical head geometry of the screw head is produced for example by grinding.

### BRIEF DESCRIPTION OF THE DRAWINGS

An exemplary embodiment of the invention is explained in more detail in the following text with reference to the figures, in which, in each case in simplified illustrations:

FIG. 1 shows a side view of a reaming tool in the form of a reamer,

FIG. 2 shows a sectional view and exploded illustration of the reamer according to FIG. 1,

FIG. 3 shows a side view of the adjustment element,

FIG. 4 shows a sectional view of the adjustment element according to FIG. 3,

FIG. 5 shows an enlarged illustration of the region B in FIG. 4,

FIG. 6 shows an enlarged illustration of the region C in FIG. 4, and

FIG. 7 shows an enlarged illustration of the region D in FIG. 4.

In the figures, parts having an identical effect are provided with the same reference signs.

### DETAILED DESCRIPTION

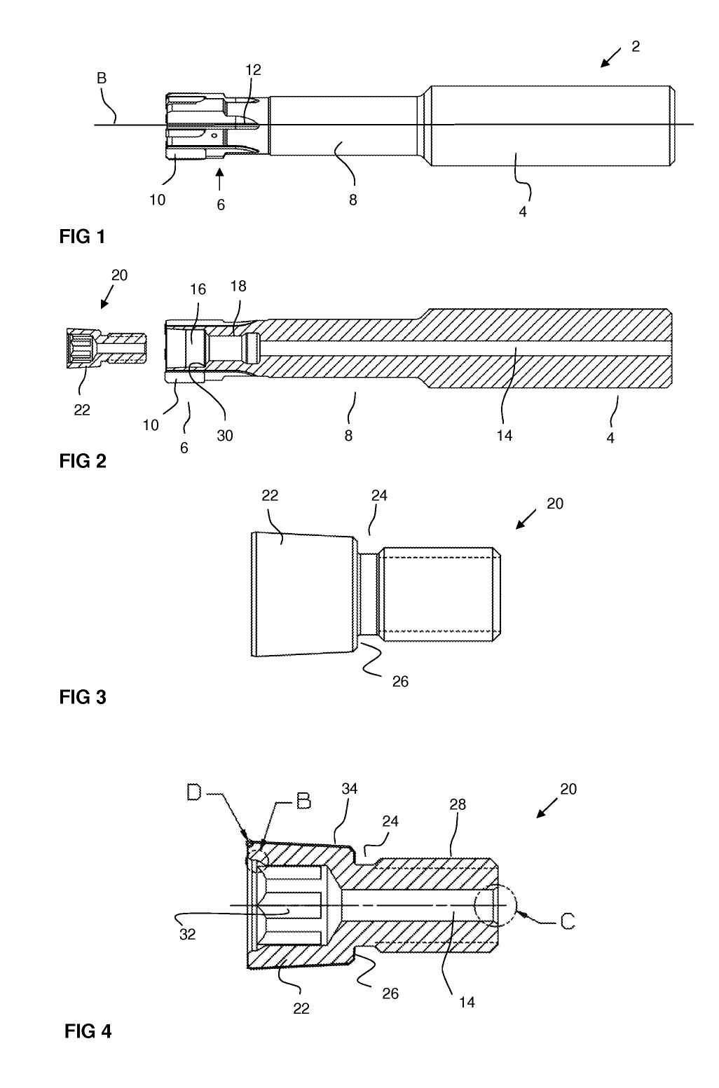

The rotary tool illustrated in FIGS. 1 and 2 is in the form of a reamer 2 which extends along a rotational and center longitudinal axis 3 from a rear shank section 4 to a front cutting section 6. The cutting section 6 is adjoined by an intermediate shank 8 which is narrowed with respect to the rear shank section 4. By way of the rear shank section 4, the reamer 2 is usually clamped into a tool receptacle of a chuck of a machine tool. During operation, the reamer 2 rotates about its center longitudinal axis 3. In the cutting section 6, a plurality of blades 10 are formed around the circumference, wherein each blade 10 is assigned a separate flute 12, said flutes extending in the exemplary embodiment in the longitudinal direction defined by the center longitudinal axis 3.

The three sections, specifically the cutting section 6, the shank section 4 and the intermediate shank 8 are—as is apparent in particular from FIG. 2—formed in one part as a monobloc.

A central coolant duct 14 extending in the longitudinal direction passes centrally through the reamer 2, in particular through this monobloc. In the region of the cutting section 6, the latter has a receiving region which is formed from a conical receptacle 16 and a threaded section 18, adjoining the latter, having an internal thread (not illustrated in more detail here).

This receiving region serves to receive an adjustment element in the form of an adjustment screw 20. The adjustment screw 20 comprises a screw head 22, which, in a manner corresponding to the conical receptacle 16, is formed in a manner narrowing conically likewise in the longitudinal direction. The screw head 22 is adjoined by an annular groove 24 such that a stop surface 26 is formed on the underside 22 of the head, said stop surface 26 extending transversely to the center longitudinal axis. The annular groove 24 is then adjoined by a shank region having an external thread 28 which is in the form of a fine thread. The stop surface 26 is assigned a counter-stop surface 30 as a base-side annular surface of the conical receptacle 16.

The cone angle, that is to say the angle at which the circumferential surface of the screw head is inclined with respect to the center longitudinal axis 3, is preferably in the range of only a few degrees, for example in the range from 2 to at most 10° and preferably less than 5°.

The coolant duct 14 is continued in the adjustment screw 20 and opens at the end side into a central tool receptacle 32. Alternatively, it is also possible for part-ducts to be guided in the manner of inclined branch bores from the central coolant duct 14 in the direction of the blades 10 and to end in the respective flutes 12.

The tool receptacle 32 is in this case in the form for example of a polygon socket. For the purposes of precision setting which is as simple as possible, markings (not illustrated in more detail here) are provided expediently on the end side of the screw head 22 and in a complementary manner on the end side region of the circumferential annular rib of the receptacle 16, wherein the distance between two markings corresponds for example to a radial widening by a defined amount.

For the precision engagement and readjustment of the radial blade position of the blades 10, the adjustment screw 20 is screwed by way of its external thread 28 into the corresponding threaded section 18. On account of the interaction of the two conical surfaces, in the form of a surface of a cone, of the receptacle 16 and the screw head 22, radial widening of the cutting section 6 within the desired tolerances is achieved.

The external thread 28, in particular fine thread, in combination with the cone angle is in this case selected in particular such that radial widening of about 2 μm of the nominal diameter is achieved per approximately 30° rotation of the adjustment screw 20. The maximum radial widening (diameter) is preferably around three times the tolerance class IT6 and thus approximately in the region of 30 μm. Therefore, preferably about 1 to 1.5 complete revolutions of the adjustment screw 20 are required or sufficient for the entire radial widening.

In order to allow adjustment which is as smooth and jerk-free as possible, the screw head 22 is provided on its circumference with a friction-reducing coating 34 which has merely a layer thickness of about 2 to 4 μm. In particular what is known as a DLC coating is in this case provided as the coating. The coating materials used are in principle materials having a low coefficient of friction, as are used as sliding layer for example also for the coating of cutting bodies.

In addition to the coating 34 on the screw head 22, the external thread 28 may also be coated. In principle, it is also possible to coat the corresponding parts of the receptacle 16, but the complexity in terms of manufacturing is greater for this.

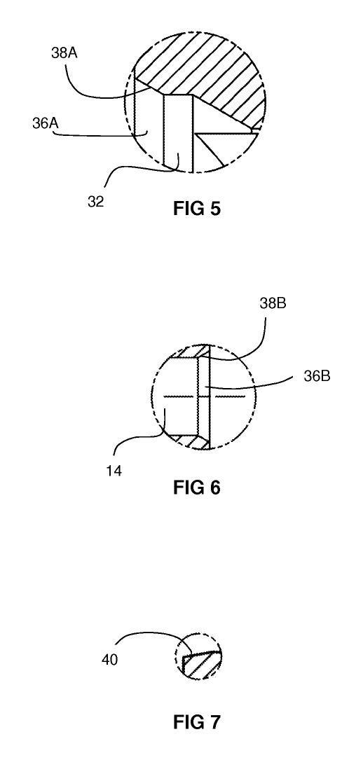

As is apparent from FIG. 4 in particular in combination with FIGS. 5 and 6, the adjustment screw 20 has, on its opposite end sides, central guide receptacles 36A, B having centering bevels 38A, B. The guide receptacles 36A, B are in this case formed by the initial region of the coolant duct 14 or by the initial region of the tool receptacle 32. These guide receptacles 36A, B serve to receive a centering and holding element during the production of the adjustment screw 20. By way of said centering and holding element, the adjustment screw 20 is held exactly centrally with respect to the center longitudinal axis 3 and as a result can be ground to the desired exact roundness within the predefined tolerances during a cylindrical grinding process. In the adjustment concept described here, this is of great significance for highly precise precision adjustment, since during the adjustment movement an excessively high tolerance in the roundness would immediately result in an excessively high tolerance of the radial expansion. The guide receptacles 36A, B having the centering bevels 38A, B therefore characterize the adjustment screw as a high precision quality part.

Furthermore—as is illustrated in FIG. 7—a circumferential outer bevel 40 is additionally formed on the outer periphery of the screw head 22, said bevel 40 allowing the adjustment screw 20 to be turned back evenly and in a highly precise manner, without difficulty of movement occurring for example on account of tilting.

The angle of the centering bevels 38A, B, which said centering bevels 38A, B take up with respect to the center longitudinal axis 3, is expediently in the range from 20° to 60° and in particular in the range from 30° to 40°. The bevel 40 in turn has a much smaller bevel angle, compared therewith, with respect to the orientation of the center longitudinal axis 3, in the range of merely about 5° to 20° and preferably of about 10°.

1-9. (canceled)

10. A rotary tool, comprising:
a cutting section extending along a center longitudinal axis, said cutting section having at least one blade on its circumference; and
an adjustment element having a cone that is inserted into an end-side receptacle in the cutting section in order to set the radial position of the at least one blade, said adjustment element being displaceable in the direction of the center longitudinal axis in order to radially widen the cutting section,
wherein the cone or the receptacle is provided with a friction-reducing coating.

11. The rotary tool of claim 10, wherein during the adjustment movement the cone rotates with respect to the receptacle about the center longitudinal axis.

12. The rotary tool of claim 10, wherein the adjustment element is a screw and the cone is formed by the screw head.

13. The rotary tool of claim 10, wherein a DLC coating is used as the friction-reducing coating.

14. The rotary tool of claim 10, wherein a stop surface oriented perpendicularly to the center longitudinal axis is formed on the adjustment element and a corresponding counter-stop surface is formed on the receptacle, said stop surface and said counter-stop surface limiting the axial adjustment movability of the adjustment element such that a radial expansion limit of the receptacle is not exceeded.

15. The rotary tool of claim 10, wherein the cone has an outer bevel on its end remote from the receptacle.

16. The rotary tool of claim 10, wherein the adjustment element has on its opposite end sides and coaxially with its center longitudinal axis central guide receptacles each having a centering bevel.

17. A reaming tool, comprising:
a cutting section extending along a center longitudinal axis, said cutting section having at least one blade on its circumference; and
an adjustment element having a cone that is inserted into an end-side receptacle in the cutting section in order to set the radial position of the at least one blade, said adjustment element being displaceable in the direction of the center longitudinal axis in order to radially widen the cutting section,
wherein the cone or the receptacle is provided with a friction-reducing coating.

18. The reaming tool of claim 17, wherein during the adjustment movement the cone rotates with respect to the receptacle about the center longitudinal axis.

19. The reaming tool of claim 17, wherein the adjustment element is a screw and the cone is formed by the screw head.

20. The reaming tool of claim 17, wherein a DLC coating is used as the friction-reducing coating.

21. The reaming tool of claim 17, wherein a stop surface oriented perpendicularly to the center longitudinal axis is formed on the adjustment element and a corresponding counter-stop surface is formed on the receptacle, said stop surface and said counter-stop surface limiting the axial adjustment movability of the adjustment element such that a radial expansion limit of the receptacle is not exceeded.

22. The reaming tool of claim 17, wherein the cone has an outer bevel on its end remote from the receptacle.

23. The reaming tool of claim 17, wherein the adjustment element has on its opposite end sides and coaxially with its center longitudinal axis central guide receptacles each having a centering bevel.

24. A rotary tool, comprising:
a cutting section extending along a center longitudinal axis, said cutting section having at least one blade on its circumference; and
an adjustment element having a cone that is inserted into an end-side receptacle in the cutting section in order to set the radial position of the at least one blade, said adjustment element being displaceable in the direction of the center longitudinal axis in order to radially widen the cutting section,
wherein a stop surface oriented perpendicularly to the center longitudinal axis is formed on the adjustment element and a corresponding counter-stop surface is formed on the receptacle, said stop surface and said counter-stop surface limiting the axial adjustment movability of the adjustment element such that a radial expansion limit of the receptacle is not exceeded,
wherein during the adjustment movement the cone rotates with respect to the receptacle about the center longitudinal axis,
wherein the cone has an outer bevel on its end remote from the receptacle,
wherein the adjustment element has on its opposite end sides and coaxially with its center longitudinal axis central guide receptacles each having a centering bevel.

25. The rotary tool of claim 24, wherein the cone or the receptacle is provided with a friction-reducing coating.

26. The rotary tool of claim 25, wherein a DLC coating is used as the friction-reducing coating.

27. The rotary tool of claim 24, wherein the adjustment element is a screw and the cone is formed by the screw head.
